(19) United States
(12) Patent Application Publication
(10) Pub. No.: US 2014/0355389 A1
(43) Pub. Date: Dec. 4, 2014

(54) METHOD AND APPARATUS FOR ESTABLISHING DEVICE COMMUNICATION

(71) Applicant: Nokia Corporation, Espoo (FI)

(72) Inventors: Jukka Reunamaki, Tampere (FI); Arto Palin, Viiala (FI); Matti Hamalainen, Lempaala (FI)

(73) Assignee: Nokia Corporation, Espoo (FI)

(21) Appl. No.: 13/904,678

(22) Filed: May 29, 2013

(51) Int. Cl. G08C 23/02

(52) U.S. Cl. CPC G08C 23/02
USPC 367/197

(57) ABSTRACT

A method, apparatus and computer program product are provided to provide for the control of a remote device. The method may include determining, with a processor, a control radius for a remote device, determining a first proximity of a user device to the remote device, in response to determining that the first proximity is within the control radius, enabling the user device to control the remote device, determining at least one command input from the user device to the remote device based on a second proximity of the user device to the remote device, and causing transmission of the command input to the remote device.

### TECHNOLOGICAL FIELD

An example embodiment of the present invention relates generally to electronic device discovery, and, more particularly, to establishing communication between devices.

### BACKGROUND

As network communication technology has become ubiquitous, it is more and more common for personal electronic devices to communicate with one another. Communication protocols such as Bluetooth, the 802.11 standards, and other personal, local, and wide area network technologies allow for these devices to establish connections for transmission of data, instructions, and the like. Network enabled devices may frequently be accessed by other users on the network, such as by using a display interface of a computer or smart phone coupled to the network. However, use of these interfaces typically requires selecting the particular device from a list to activate an interface to the device, and then using a series of menus to perform the particular desired interaction with the device. In some cases, the user may not be sure which listed device corresponds to the physical device to which the user wishes to connect. Additionally, where the user device is a smart phone or other mobile device, the size of the display screen may hinder the ability to interact with the remote device.

### BRIEF SUMMARY

A method, apparatus and computer program product are provided in accordance with an example embodiment of the present invention in order to facilitate the control of a remote device using a user device. In one embodiment, a method, apparatus and computer program product may determine that one or more remote devices are present in the vicinity of a user device. A control radius may be determined for the user device and/or the remote devices, such that the user device may be configured to provide a control interface for remote devices within the control radius of the user device. Upon entering the control radius of the user device or one of the remote devices, the user device may be configured to provide input to the remote device via input relating to the proximity of the user device to the remote device. For example, the user device may be configured to provide input to the remote device based on the physical distance between the remote device and the user device. Embodiments may further provide for determining the physical distance using acoustic cues. As such, the method, apparatus, and computer program product may permit the control of a remote device by a user device, such that input is provided based at least in part on the proximity of the user device to the remote device.

Example embodiments may include a method. The method may include determining, with a processor, that a radio frequency signal strength of one or more messages at least one of received from or transmitted to a remote device exceeds a threshold level. The method may also include, in response to determining that the signal strength of the one or more messages received from or transmitted to the remote device exceeds the threshold level, triggering acoustic signal based proximity detection for enabling controlling the remote device. The threshold level for the radio frequency signal strength may be associated with a control radius for the remote device for triggering acoustic signal based proximity detection. The acoustic proximity measurement technique may include at least one of measuring a sound wave propagation time from a speaker of one of a user device or the remote device to a microphone of the other of the user device or the remote device. The acoustic signal based proximity detection may be used to enable gesture based control of the remote device. In some embodiments, the method of claim 3, wherein the user device is a cellular phone.

In some embodiments, the remote device may include a speaker. The acoustic signal based proximity detection may be used to at least one of change the volume of the speaker, change the direction of the speaker output, or initiate output by the speaker of audio received from a user device. The method may also include receiving a gesture input by acoustic signal based proximity detection to control the volume of the speaker by rotating the user device in a clockwise manner to increase the volume and a counter-clockwise manner to decrease the volume.

In some embodiments, the remote device includes a display. The method may include receiving a gesture input by acoustic signal based proximity detection to alter the contents of the display.

In some embodiments, the method may include receiving a gesture input by acoustic signal based proximity detection, and, in response to receiving the gesture input, causing a file to be at least one of sent to or received form the remote device.

Example embodiments may also include an apparatus. The apparatus may include a processor and a memory storing program code instructions therein. The memory and program code instructions may be configured to, with the processor, cause the apparatus to at least determine that a radio frequency signal strength of one or more messages at least one of received from or transmitted to a remote device exceeds a threshold level, and in response to determining that the signal strength of the one or more messages received from or transmitted to the remote device exceeds the threshold level, the apparatus may be configured to trigger acoustic signal based proximity detection for enabling controlling the remote device. The threshold level for the radio frequency signal strength may be associated with a control radius for the remote device for triggering acoustic signal based proximity detection. In some embodiments, the acoustic proximity measurement technique includes at least one of measuring a sound wave propagation time from a speaker of one of a user device or the remote device to a microphone of the other of the user device or the remote device. The acoustic signal based proximity detection may be used to enable gesture based control of the remote device.

In some embodiments, the apparatus may be further configured to use acoustic signal proximity detection to at least one of change the volume of a speaker, change the direction of an output of the speaker, or initiate output by the speaker of audio received from the apparatus. The apparatus may be further configured to receive a gesture input by acoustic signal based proximity detection to control the volume of the speaker by rotating the user device in a clockwise manner to increase the volume and a counter-clockwise manner to decrease the volume. In some embodiments, the apparatus may be further configured to receive a gesture input by acoustic signal based proximity detection to alter the contents of a display. In yet further embodiments, the apparatus may be further configured to receive a gesture input by acoustic signal based proximity detection, and, in response to receiving the gesture input, cause a file to be at least one of sent to or received form the remote device. In some embodiments, the apparatus is a cellular phone.

Example embodiments may also include a computer program product comprising at least one non-transitory computer-readable storage medium having executable computer-readable program code portions stored therein. The computer-readable program code portions may include a first program code configured to, upon execution, cause an apparatus to determine that a radio frequency signal strength of one or more messages at least one of received from or transmitted to a remote device exceeds a threshold level. The computer-readable program code portions may also include a second program code configured to, upon execution and in response to determining that the signal strength of the one or more messages received from or transmitted to the remote device exceeds the threshold level, cause the apparatus to trigger acoustic signal based proximity detection for enabling controlling the remote device. The acoustic signal based proximity detection may be used to enable gesture based control of the remote device.

### BRIEF DESCRIPTION OF THE DRAWINGS

Having thus described certain example embodiments of the present invention in general terms, reference will hereinafter be made to the accompanying drawings, which are not necessarily drawn to scale, and wherein:

FIG. 1 is a block diagram of an apparatus that may be specifically configured in accordance with some example embodiments of the present invention;

FIG. 2A is an illustration of a user device in communication with a remote device in accordance with some example embodiments of the present invention;

FIG. 2B is an illustration of a remote device within a control radius of a user device in accordance with some example embodiments of the present invention;

FIG. 2C is an illustration of a remote device controlling a remote device using a proximity in accordance with some example embodiments of the present invention;

FIG. 3 is an illustration of a control radius between a remote device and a user device in accordance with some example embodiments of the present invention;

FIG. 4 is a flow chart depicting an example of a method for controlling a remote device with a user device in accordance with some example embodiments of the present invention, such as may be performed by the apparatus depicted with respect to FIG. 1;

FIG. 5 is a flow chart depicting an example of a method for controlling a remote device in accordance with some example embodiments of the present invention, such as may be performed by the apparatus depicted with respect to FIG. 1.

FIG. 6 is a block diagram depicting the use of an acoustic proximity detection technique to determine a distance between two devices in accordance with some example embodiments of the present invention;

FIG. 7 is a flow diagram depicting an example of a method for detecting a physical distance using an acoustic measurement technique in accordance with some example embodiments of the present invention, such as may be performed by the apparatus depicted with respect to FIG. 1;

FIG. 8 is a flow diagram depicting an example of a method for controlling a remote device with a user device in accordance with some example embodiments of the present invention, such as may be performed by the apparatus depicted with respect to FIG. 1;

FIG. 9 is a flow diagram depicting an example of a method for controlling a remote device using radio frequency signal strength and acoustic proximity detection techniques in accordance with some example embodiments of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment of the present invention in order to enable control of a remote device by a user device. The control of the remote device may be performed by determining a proximity between the user device and the mobile device. The proximity may be determined within a particular control radius defined between the user device and the mobile device. As such, the method, apparatus and computer program product of an example embodiment permit a user to control a remote device in an intuitive, flexible manner which might otherwise be difficult or impractical.

The method, apparatus and computer program product of some example embodiments may cause a user device to identify remote devices, such as by detecting remote devices coupled to a same network as the user device. Upon detection of the remote devices, the user device may determine a control radius such that if the distance between the user device and a particular, remote device is less than the control radius, control of the particular remote device is enabled. This control radius may be established by communication between the user device and the remote devices. In some embodiments, when the distance between the user device and the particular remote device is less than the control radius, the user device and the remote device may employ an acoustic proximity detection technique using acoustic waves. In this regard, the user device and the remote device may be a mobile terminal, such as a portable digital assistant (PDA), mobile telephone, smartphone, pager, mobile television, gaming device, laptop computer, camera, tablet computer, touch surface, video recorder, audio/video player, radio, electronic book, positioning device (e.g., global positioning system (GPS) device), or any combination of the aforementioned, and other types of voice and text communications systems. Alternatively, the computing device may be a fixed computing device, such as a personal computer, a computer workstation or the like. In embodiments employing acoustic proximity detection techniques, the user device and/or the remote device may also include hardware and software for performing the acoustic proximity detection techniques. For example, the user device and/or the remote device may include microphones, speakers, and/or the like.

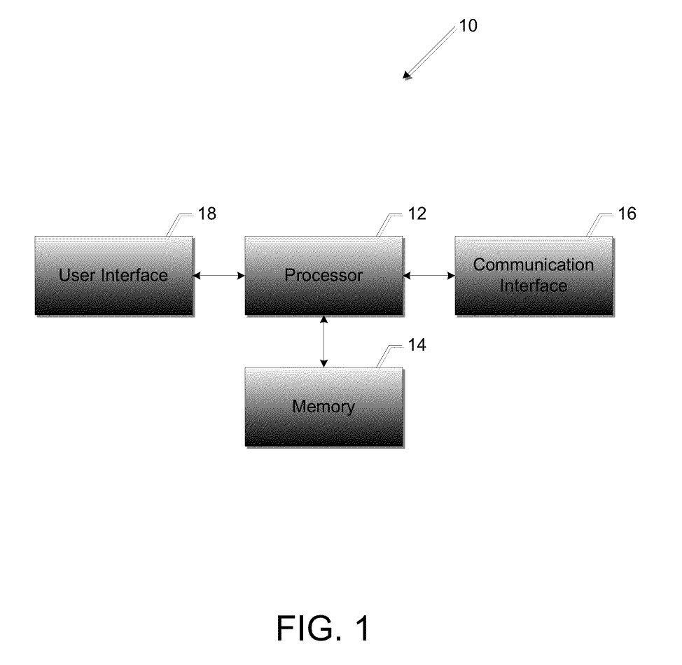

An example embodiment of the invention will now be described with reference to FIG. 1, in which certain elements of an apparatus 10 for enabling control of a remote device by a user device. The apparatus of FIG. 1 may be employed, for example, as a user device or as a remote device to assist with determining proximity between the user device and the remote device, and to enable control of the remote device if the proximity indicates that the user device is within a control radius of the remote device (or vice/versa). It should be understood that, while the control radius may be described with as a radius around a particular user device or around a particular remote device, the terminology could equally apply to the other type of device (e.g., the radius could be a radius around the user device that enables control of remote devices within the radius, or the radius could be a radius around a remote device that enables control by user devices within the radius). For example, the apparatus may be embodied by a mobile terminal or a fixed computing device that includes or is otherwise associated with the display. Alternatively, the apparatus may be separate from the computing device or at least from the display that is associated with the computing device, but the apparatus of this embodiment may be in communication with the computing device, such as via wireline or wireless communications, in order to direct the presentation of the visual representation(s) of the audio characteristic(s) of the one or more audio files upon the display. In some embodiments, the apparatus is a speaker system incorporating processing circuitry for communication with and control by a user device.

It should also be noted that while FIG. 1 illustrates one example of a configuration of an apparatus 10 for enabling control of a remote device by a user device, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 1, the apparatus 10 may include or otherwise be in communication with a processor 12, a memory device 14, a communication interface 16 and optionally a user interface 18. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 10 may be embodied by a computing device, such as a mobile terminal or a fixed computing device. However, in some embodiments, the apparatus may be embodied as a chip or chip seta. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12 may be configured to execute instructions stored in the memory device 14 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 16 may be any means such as a device or circuitry embodied in either hardware or a combination of hardware and software that is configured to receive and/or transmit data from/to a network and/or any other device or module in communication with the apparatus 10. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms

In some embodiments, the apparatus 10 may include a user interface 18 that may, in turn, be in communication with the processor 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a speaker, one or more accelerometers, or other input/output mechanisms. In one embodiment, the user interface may include a mechanism by which a user device may control or otherwise interact with the remote device. Alternatively or additionally, the processor may comprise user interface circuitry configured to control at least some functions of one or more user interface elements such as a display and, in some embodiments, a speaker, ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 14, and/or the like).

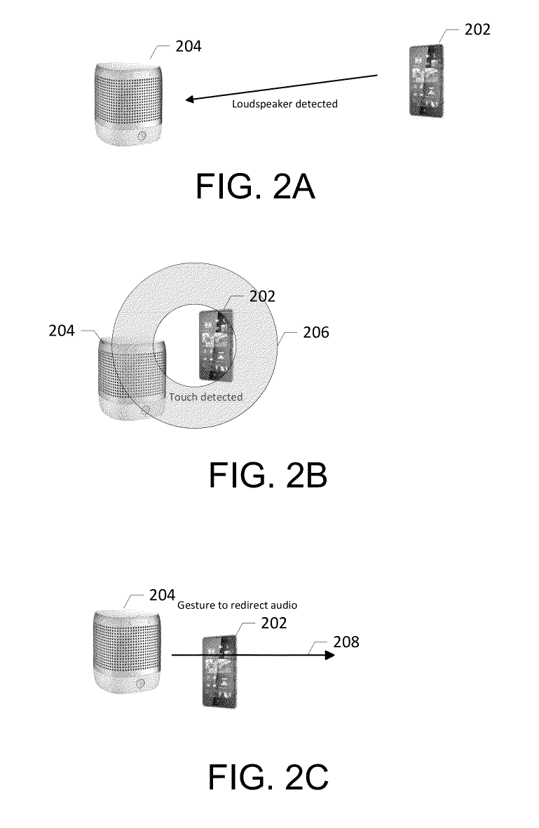

Referring now to FIGS. 2A-2C, the operations performed, such as by the apparatus 10 of FIG. 1, in accordance with an example embodiment are illustrated. FIG. 2A depicts a user device 202 in communication with a remote device 204. In the present example, the user device 202 is depicted as a mobile phone or “smart phone” and the remote device 204 is depicted as a speaker. However, it should be readily appreciated that the user device 202 and the remote device 204 may be various additional or alternative devices such as described above with respect to the apparatus 10 of FIG. 1. In FIG. 2A, the user device 202 detects the presence of the remote device 204. This initial detection may include a network discovery process whereby the user device 202 identifies one or more remote devices coupled to the network. For example, the user device 202 may discover remote devices via any network discovery process, such as via a Bluetooth® discovery process.

Upon discovery of the remote device 204, the user device 202 may determine a control radius for the remote device 204, such that control of the remote device 204 is enabled when the proximity between the user device 202 and the remote device 204 is less than the length of the control radius. In some embodiments, the distance between the user device 202 and the remote device 204 may be determined via a Received Signal Strength Indication (RSSI) method. The RSSI method functions to determine the distance between two devices by measuring the signal strength of transmissions between the two devices. In circumstances where the relative power and configuration of each device is known (e.g., data may be communicated across devices via a network, such as a network that enabled the discovery process), the RSSI method may provide an estimate of the distance between the two devices.

FIG. 2B illustrates the user device 202 entering the control radius 206 to establish control of the remote device 204. As described above, determining whether the device has entered the control radius may be performed using an RSSI method or other technique for determining device proximity. When the user device 202 enters the control radius 206, one of the user device 202 and the remote device 204 may notify the other that control has been established by the user device 202. In some embodiments, when the user device 202 enters the control radius 206, an input method is activated for the user device 202. For example, the user device 202 may activate an acoustic proximity detection technique to provide increased accuracy in range and proximity detection between the user device 202 and the remote device 204. In this manner, the use of such higher precision techniques may be limited to scenarios where such input is necessary (e.g., the user has indicated they wish to control a particular remote device 204 by entering the control radius 206), thus saving device power, and preventing unintended inputs (e.g., where the user device is within a user's pocket across the room).

FIG. 2C illustrates the user device 202 controlling the remote device 204 using a gesture 208. In the present example, the user device 202 is depicted controlling the direction of the speaker audio output of the remote device 204 using a gesture 208, such that the speaker audio output is directed in the direction indicated by the gesture 208. By entering within the control radius 206, the user device 202 may have enabled control of the remote device 204 via a more precise measurement technique, such that the gesture input is received using the more precise technique, thus providing for increased accuracy in the detection of gesture input and thus control of the device.

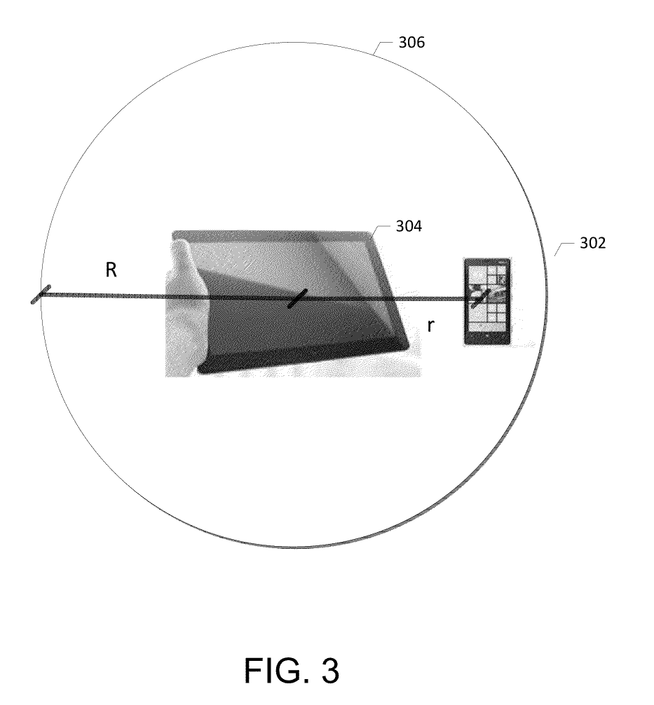

FIG. 3 illustrates another interaction between a user device 302 and a remote device 304. The remote device 304 includes a control radius 306, defined by a particular distance R. In the example, in response to the distance of the user device 302 to the remote device 304, defined as r, being less than R, the user device 302 may be enabled to control the remote device 304. In some embodiments, the user device 302 may retain the ability to control the remote device 304 even after leaving the control radius (e.g., entry into the control radius 306 may initiate control of the remote device 304, and another factor other than the distance between the user device 302 and the remote device 304 may determine if control of the remote device 304 should be disabled). As such, since in the present example r is smaller than R, the user device 302 would be enabled to control the remote device 304. It should be readily appreciated that control of the remote device 304 may be established in a variety of manners initiated by the remote device 304, the user device 302, a third party device (not shown), or any combination thereof. For example, the user device 302 may determine the radius R defining the control radius 306 during discovery of the remote device, and perform subsequent measurements of the distance r to detect when R>r. Upon detecting that R>r, the user device 302 may initiate control or another interaction with the remote device 304. Alternately, the user device 302 may inform the remote device 304 of the distance, and perform a handshaking process with the remote device 304 and/or a third party device to initiate the control operation.

In some embodiments, different control radii may be used to enable different control functionalities. For example, a first, larger control radius may enable a first functionality on a device, and a second, smaller control radius may enable additional functionality or include a refinement of the first functionality. As an example, if the remote device is capable of providing multimedia output from the user device (e.g., audio playback), a first control radius may enable selection of a song from a playlist using the user device. However, the song may not begin playback of the song until the user device enters a smaller control radius (e.g., touching the remote device). As such, it should be readily appreciated that embodiments are not limited to a particular number of control radii, and that different control radii may be mapped to different control functionality for control operations performed between the user device and the remote device.

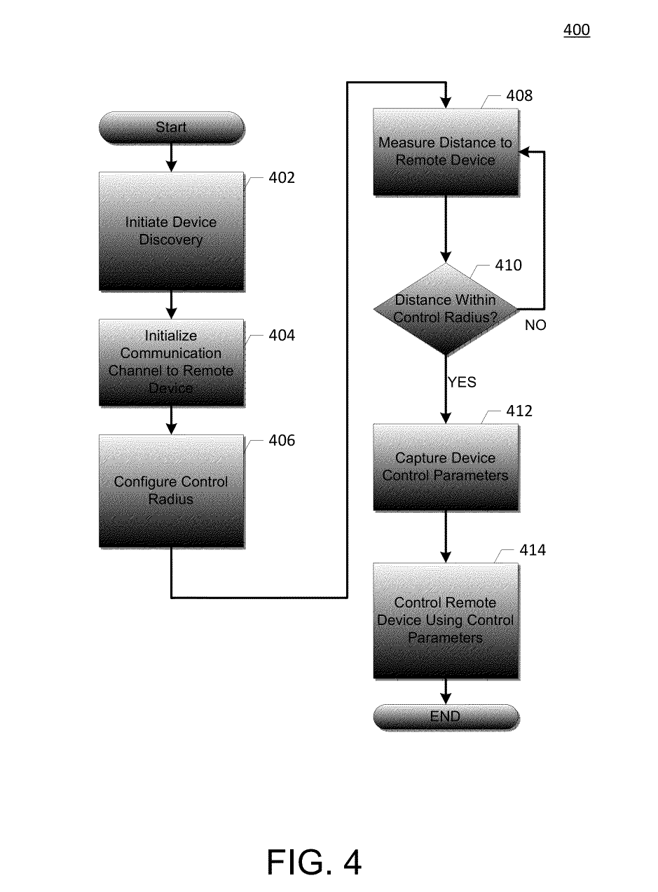

FIG. 4 illustrates a flow diagram depicting an example of a method 400 in accordance with some example embodiments. The method 400 may be operable to enable a user device to control a remote device as described above with respect to FIGS. 1-3. The method 400 may be performed by an apparatus, such as the apparatus 10 described with respect to FIG. 1. The apparatus 10 may include various means for performing the steps of the method 400. A computing device that embodies the apparatus may include a processing means for performing one or more steps of the method 400. For example, the method may be performed by an apparatus configured as a user device embodying processing circuitry that acts as a means to perform the steps of the described method.

At action 402, a device discovery operation may be initiated. As described above, the device discovery operation may be used to identify devices that are available for possible control by a user device. The device discovery operation may involve identifying the presence of other devices via various local area or point-to-point network protocols, including but not limited to Bluetooth®, ZigBee®, the 802.11 protocol family, and the like. The device discovery operation may be performed via a processing means, such as described above with respect to the apparatus 10.

At action 404, a communication process is initialized with one or more of the remote devices identified during the device discovery operation. In this manner, the user device may communicate with the identified devices for the purpose of configuring the user device and/or the remote device for potential control by the user device. Communication may be caused to be initiated via a processing means, such as described above with respect to the apparatus 10.

At action 406, a control radius is determined via the communication process initialized at action 404. The user device and the remote device may thus determine a particular distance within which the user device will be configured to control or otherwise interface with the remote device. The control radius may be configurable by the user device (e.g., the user may specify a control radius), by the remote device (e.g., the remote device may be configured to operate according to a particular control radius), or a combination thereof. In some embodiments, the control radius may be dynamically determined based on various factors, including but not limited to the type of device of the user device and the remote device, the number of remote devices visible to the user device, interference levels, signal strength indicators, or the like. The control radius may be determined via a processing means, such as described above with respect to the apparatus 10.

At action 408, a distance is measured from the user device to the remote device. This distance may be measured in a variety of manners, such as by using the RSSI method described above with respect to FIG. 2. The distance measurement may be used to determine whether the user device is within the control radius of the remote device as determined at action 406. The distance may be determined by a processing means, such as described above with respect to the apparatus 10.

At action 410, a determination is made as to whether the distance from the user device to the remote device is less than the length of the control radius. If the distance is less than the length of the control radius, then the user device may be enabled to control the remote device at action 412. Otherwise, the method 400 may return to action 408 to continue monitoring of the distance to detect if/when the user device enters the control radius for the remote device or another remote device. The determination may be made by a processing means, such as described above with respect to the apparatus 10.

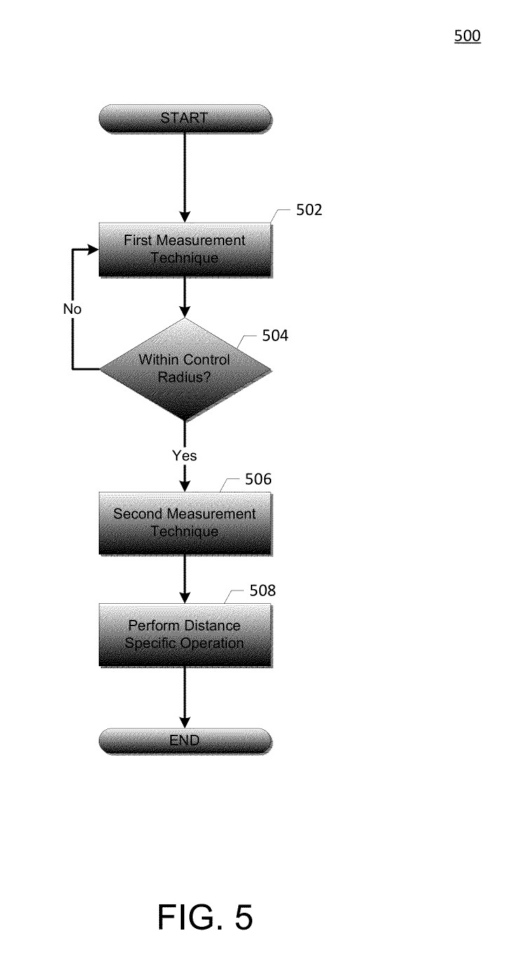

At action 412, the user device may provide input to control the remote device. The input provided by the user device may include gesture inputs, text commands, commands provided by an application interface, or any other method of providing input used for control of the remote device, such as described above with respect to FIG. 2C. In some embodiments, gestures may be received as input by determining the distance between the user device and the remote device. The gestures may be detected using a process for measuring distance other than the process that determined whether the user device was within the control radius of the remote device. For example, the user device may detect whether the user device is within the control radius of the remote device using an RSSI method, but, upon entering the control radius, switch to an alternative method, such as an acoustic proximity detection method, for additional distance calculations. In some embodiments, the second process for measuring distance may be more accurate or precise than the first process, enabling finer control based on distance when control of the remote device is enabled. Example methods and apparatuses for detecting gesture input using an acoustic proximity detection method are described further below with respect to FIGS. 5-7. The input may be detected by a processing means, such as described above with respect to the apparatus 10.

After detection of the input at action 412, commands, controls, instructions, or the like corresponding to the input may be provided to the remote device at action 414 to control the remote device. The input may be translated to commands and caused to be sent to the remote device by a processing means, such as described above with respect to the apparatus 10.

FIG. 5 illustrates a flow diagram of an example of a method 500 for controlling a remote device using a user device in accordance with some example embodiments. The method 500 illustrates how two distance measurements may be used to enable control of a particular remote device, and to provide input to the particular remote device. The method 500 provides for the use of multiple distance measurement techniques, advantageously allowing for coarser, longer range techniques to be employed to determine whether the user device is within the control radius, followed by more accurate, shorter range techniques to detect particular inputs based on proximity. The method 500 may be performed by a user device, such as a user device configured as an apparatus 10 as described with respect to FIG. 1. The method 500 and elements thereof may be performed by a processing means, such as the processor 12 described with respect to FIG. 1.

At action 502, a first measurement technique is used to determine the distance between a user device and a remote device. As described above, this first measurement technique may be a RSSI method as known in the art. Although discussed with respect to an RSSI technique, it should be readily apparent that alternative techniques for determining the distance may also be employed, including but not limited to the use of global positioning system (GPS) coordinates, visual acquisition methods using device cameras, the use of radio frequency identification (RFID) or near-field communication (NFC) techniques, or the like. The distance may be measured by these techniques being performed by a processing means, such as the processor 12 described with respect to FIG. 1.

At action 504, a determination is made as to whether the distance from the user device to the remote device is less than the length of the control radius. If the distance is less than the length of the control radius, then the user device may be enabled to detect a distance according to a second measurement technique at action 506. Otherwise, the method 500 may return to action 502 to continue monitoring of the distance to detect if/when the user device enters the control radius for the remote device or another remote device. The determination may be made by a processing means, such as the processor 12 described above with respect to FIG. 1.

At action 506, the second measurement technique is employed to determine one or more distances between the user device and the remote device. With reference to embodiments as described above, the second measurement technique may be employed when the user device enters the control radius of the remote device. This second measurement technique may provide a more accurate method of determining distance than the first measurement technique, allowing user input to be received based on the change in distance between the user device and the remote device. In some embodiments, the first measurement technique may not have an accuracy or precision level sufficient to accurately determine changes in the distance between the user device and the remote device, and thus the first measurement technique may not be suitable for identification of input derived from the location of the user device. In contrast, the second measurement technique may provide sufficient precision and accuracy to allow the user to perform inputs based on the proximity of the user device to the remote device (e.g., gesture input) to control the remote device. The second measurement technique may be caused to be performed by a processing means, such as the processor 12 described above with respect to FIG. 1.

At action 508, the distance measurement(s) derived based on the second measurement may be used to control the operation of the remote device. For example, as described above, the proximity of the user device to a speaker system may be used to control the direction of output of the speakers. As further examples, such proximity measurements could be used to control file transfer operations (e.g., tilting an end of the user's phone downwards when proximate to another user's phone might cause a copy operation of a file displayed on the second user's phone to the first user's phone), streaming services (e.g., moving a user's phone within a certain distance of a speaker system might enable streaming of the phone audio output to the speaker system), or other user or remote device-specific input operations (e.g., moving the user device in a counter-clockwise manner when within the control radius of a speaker system to adjust the volume of the speaker system). As yet another example, in some embodiments the remote device may include a display, and proximity measurements may be used to control the contents of the display (e.g., an image presented on the display). For example, proximity measurements may be used to initiate a video streaming operation from the user device to the remote device's display. The control operation may be performed by a processing means, such as the processor 12 described with respect to FIG. 1.

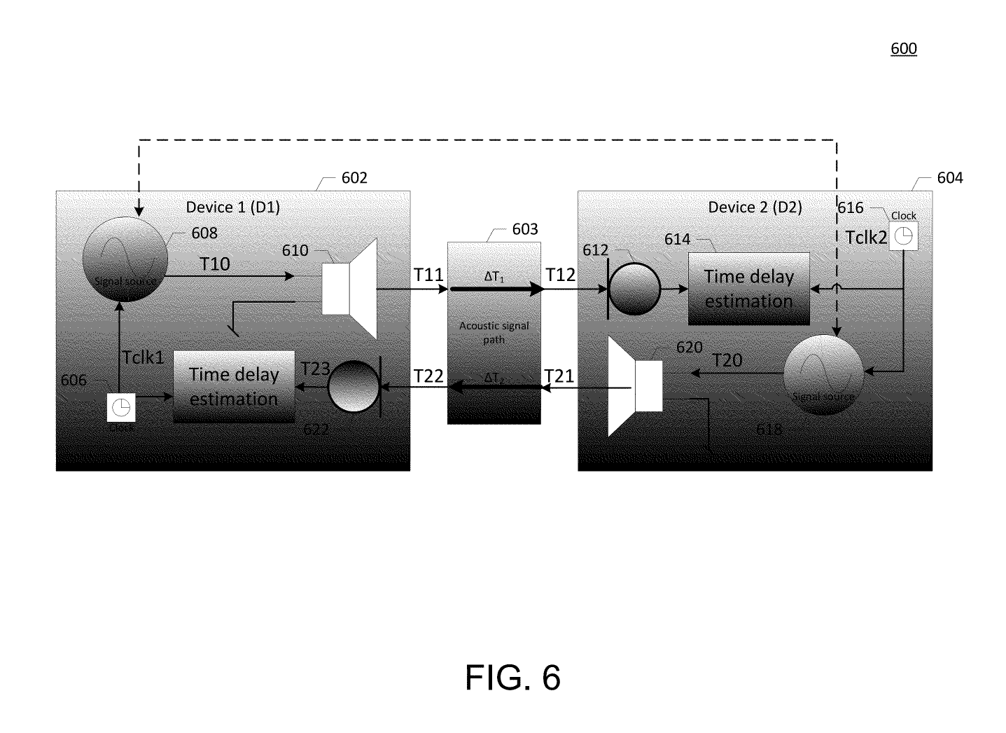

FIG. 6 is a block diagram depicting the use of an acoustic proximity detection technique to determine a distance between two devices 600 in accordance with some example embodiments of the present invention. The illustration depicts a first device 602 and a second device 604 employing an acoustic proximity detection technique to determine a distance between the two devices. For example, the first device 602 may be a user device and the second device 604 may be a remote device as described above with respect to FIGS. 2-5.

The estimation of physical distance between the two devices may be based on the time for sound waves to propagate over the air between the two devices, allowing for additional time associated with processing delays upon receiving an audio transmission. In the present example, a first signal source 608 generates a signal at a time defined by a first clock 606. The signal source 608 may be, for example, a processor or processing means as described above with respect to FIGS. 1-5. The signal sent by the signal source 608 may be output by a speaker 710 after a delay T10, accounting for the time between when the processing circuitry causes transmission of the signal and when the signal is actually output by the speaker. In some embodiments, the delay T10 is known to the first device 602 (e.g., based on known a priori properties of the sound hardware of the device), and transmitted to the second device 604 by an alternate communication channel (e.g., a network or radio connection).

In some embodiments, the clock 606 of the first device 602 may not synchronized with the clock 616 of the second device 604. As such, it may be appropriate to account for this delay during propagation of the acoustic signal by considering the fact that each clock is offset from a global reference clock by a particular value. Assuming the signal leaves the first device 602 at time T11, and is received by the microphone 612 of the second device at time T12, the offset value for each clock 606, 616 may be determined according to the following calculations:

T11+T_{offset1}+ΔT=T12+T_{offset2} (1)

Where T_{offset1} is the offset for the first clock 606, ΔT is the propagation time for the acoustic wave between the two devices, and T_{offset2} is the offset for the second clock 616. From this equation, it is possible to determine that:

ΔT=T12−T11+T_{offset2}T_{offset1} (2)

such that the difference in global time offset is:

T_{offset}=T_{offset2}−T_{offset1} (3)

When sending the acoustic signal, the first device 602 may inform the second device 604 of the time T11 at which the signal was sent. This time may be transmitted via a second network connection, or encoded within the acoustic signal. If the offset between the two clocks is known, then the distance between the two devices 602, 604 may be calculated using the speed of sound multiplied by the propagation time ΔT. In some embodiments, the speed 343 meters/second may be used as an estimate for the speed of sound, making assumptions for certain factors that may influence the speed such as temperature, air pressure, and humidity.

However, in embodiments where the offset between the clocks is not known a priori, the distance may nonetheless be determined accurately using an additional acoustic wave. As depicted in FIG. 6, an additional acoustic wave may be sent by a signal source 618 the second device 604 at time T20, propagated by a speaker 620 of the second device at time T21, and received by a microphone 622 of the first device 602 at time T22. In this manner, the value of T_{offset} may be calculated by the following formulae:

T11+ΔT₁=T12+T_{offset} (4)

T21+ΔT₂=T22−T_{offset} (5)

Between two consecutive measurements it may be assumed that clock drifting can be ignored and the devices have not moved significantly so that the propagation time and distance remains relatively constant, such that ΔT₁≈ΔT₂=ΔT. Therefore, equations (4) and (5) (where T11, T12, T21, and T22 are known by the system) can be written in the form

T_{offset}=T11−T12+ΔT=T22−T21−ΔT (7)

The transmission delay can be obtained by averaging two-way time delay measurements:

ΔT=(T12−T11+T22−T21)/2 (8)

Or, alternatively, by assuming that devices are not moved between the two acoustic signals, the clock offset can be calculated:

T_{offset}(T11−T12+T22−T21)/2 (9)

In this manner, it is possible to accurately determine the propagation delay of acoustic signals between two devices, accounting for overhead delays resulting from transmission delays between the signal source 608 to the speaker 610, and for drift between the first clock 606 and the second clock 616. Once the propagation delay is known, the distance between the devices may be calculated by multiplying the propagation delay by the known speed of the acoustic wave (e.g., the speed of sound) to obtain the distance.

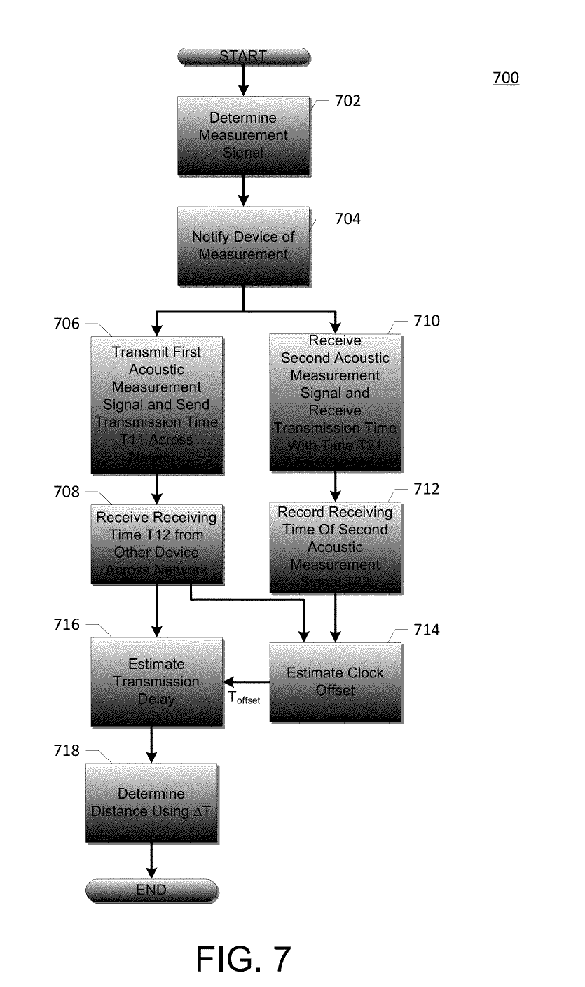

FIG. 7 depicts a flow diagram of an example of a method 700 for calculating a distance between two devices using an acoustic proximity detection technique such as described above with respect to FIG. 6. The method 700 may be performed to determine a more precise distance measurement than RSSI techniques to assist with performing user input to a remote device via a user device as described with respect to FIGS. 2-5. For example, the acoustic proximity detection technique may function as the second measurement technique described with respect to action 506 of FIG. 5. The method 700 may be employed by one or more processing means coupled to an apparatus, such as the user device or remote device as described above, examples of which are further described with respect to the apparatus 10 of FIG. 1.

At action 702, parameters are determined for a measurement signal. For example, a user device may enter the control radius of a remote device and wish to perform a gesture control of the remote device. In some embodiments, the user may use an interface control of the remote device (e.g., a button or touchscreen input) to initiate the measurement operation when within the control radius, or in some embodiments the detection process may happen automatically. The parameters may include a negotiation or handshaking process between the user device and the remote device to ensure that both devices are prepared to perform their respective portions of the acoustic proximity detection technique. The determination of the parameters for the measurement signal may be performed by a processing means, such as a processor 12 as described above with respect to the apparatus 10.

At action 704, the user device notifies the remote device to begin to propagate the acoustic measurement signal. The user device and the remote device may be connected via a communication channel, such as over a network. Thus, the notification may be sent over this channel. The user device may cause transmission of a “start” signal at which time one or both of the devices will transmit an acoustic measurement signal. In some embodiments, one of the devices is designated to transmit the acoustic measurement signal first, such that the second device will not transmit the acoustic measurement signal until a first acoustic measurement signal is received. The notification may be caused to be sent by a processing means, such as the processor 12 described above with respect to the apparatus 10.

Actions 706-708 and 710-712 are depicted in parallel in the present example, as each relates to a transmission or reception, respectively, of particular acoustic measurement signals. Although these actions are depicted in parallel, it should be readily appreciated that they could occur in series (e.g., transmission of the first acoustic measurement signal followed by transmission of the second acoustic measurement signal after the first transmission is complete), or in any other order or organization.

At action 706, the user device may transmit the first acoustic measurement signal, and notify the remote device of the transmission time T11 using the network channel. At action 708, a notification of the time T12 at which the remote device received the first acoustic measurement signal is received from the remote device over the communication channel. The actions 706-708 may be performed by a processing means, such as a processor 12 as described above with respect to the apparatus 10.

At action 710, the second acoustic measurement signal and a time value T21 for the second acoustic measurement signal are received. The second acoustic measurement signal may be received via a microphone coupled to the user device, and the time value may be received from the remote device via the communication channel. The second acoustic measurement signal and the time value may be detected by a processing means coupled to the microphone and communication circuitry for accessing the communication channel, such as the processor 12 described above with respect to the apparatus 10.

At action 712, the user device may determine the time T22 at which the second acoustic measurement signal was received and record the time for use in future calculations. The time may be determined by a processing means, such as the processor 12 described above with respect to the apparatus 10.

At action 714, the offset time between clock sources for the user device and the remote device is determined using the time values determined for the two acoustic measurement signals, such that T_{offset}=(T11−T12+T22−T21)/2. The offset time may be determined using a processing means, such as the processor 12 described above with respect to the apparatus 10.

At action 716, the actual signal propagation time may be calculated, factoring in the transmission delay, by averaging the difference of the transmission and reception times for each acoustic measurement wave, such that ΔT=T12−T11+T_{offset}. The transmission delay may be calculated by a processing means, such as the processor 12 described above with respect to the apparatus 10.

At action 718, the signal propagation time is used in conjunction with the speed of sound to determine a distance between the two devices. This distance may be calculated by a processing means, such as the processor 12 described above with respect to the apparatus 10.

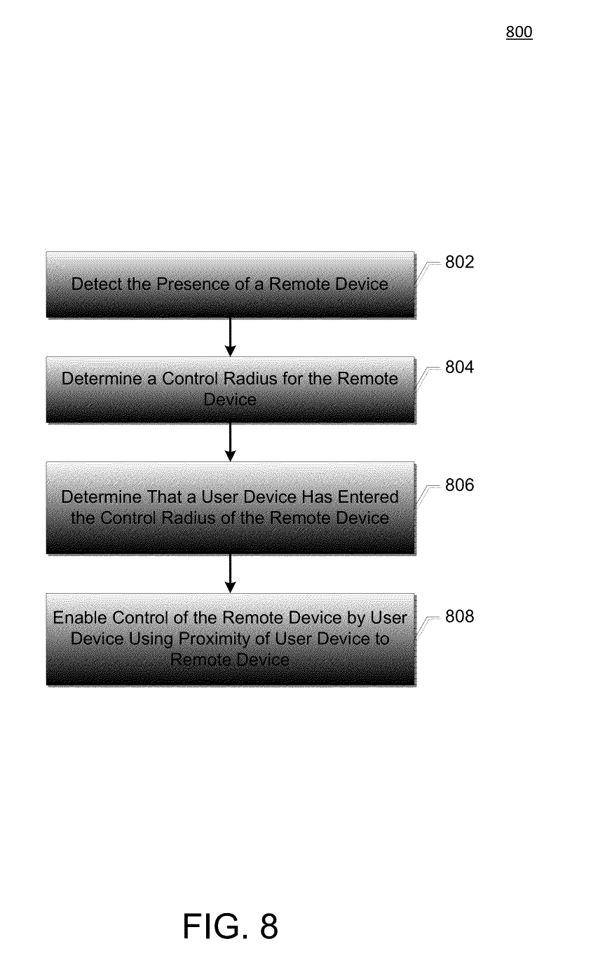

FIG. 8 depicts a flow diagram of an example of a method 800 for controlling a remote device based on proximity in accordance with some example embodiments. As described above, embodiments may provide for the ability to control a remote device using a user device based on the proximity of the user device to the remote device. Upon entering a control radius of the remote device, the user device may be enabled to control the remote device. In some embodiments, control of the remote device is performed using proximity information, and the proximity information may be derived by a different method than originally employed to determine that the user device entered the control radius of the remote device. In this manner, the method 80 may provide for the ability to dynamically determine methods used for determining device proximity based on whether the user device is within a control radius of a remote device. Embodiments of the method 800 may be performed by an apparatus, or a processing means of an apparatus, such as the processor 10 described above with respect to the apparatus 10.

At action 802, a presence of a remote device is detected. As described above with respect to FIGS. 2-5, the user device may detect the presence of one or more remote devices such as by using network discovery techniques. Discovering these remote devices may involve establishing a communication channel with the remote device or with a third party responsible for managing the remote device. The presence of the remote device may be detected by a processing means, such as a processor 10 as described above with respect to the apparatus 10.

At action 804, a control radius for the remote device is determined. As described above with respect to FIGS. 2-5, the control radius may be determined in a variety of manners, such as based on the specifications or capabilities of the user device, the remote device, third party devices in communication with the user device and/or remote device, the environment of the user device or the remote device, or the like. The control radius may define a particular distance within which the user device may be configured to control the remote device, such as a radius within which gestures performed using the user device will induce a particular behavior or processing by the remote device. The control radius may be determined by a processing means, such as a processor 12 as described above with respect to the apparatus 10.

At action 806, a determination is made that the user device is within the control radius of the remote device. As described above with respect to FIGS. 2-5, the determination may be performed by the user device itself, by the remote device, by a third party device, or by any combination thereof. In some embodiments, the determination may be made by a processing means of the user device, such as a processor 12 as described above with respect to the apparatus 10.

At action 808, communication and/or control of the remote device is enabled for the user device based on the proximity of the user device, in response to the user device being within the control radius. In some embodiments, entry within the control radius may activate an alternative technique for determining the proximity of the user device to the remote device, such as the acoustic proximity measurement technique described with respect to FIGS. 5-7. In some embodiments, the interaction between the user device and the remote device may be performed via gesture inputs detected using the proximity measurements. The control of the remote device may be performed by a processing means determining input to the remote device based proximity, such as a processor 12 as described above with respect to the apparatus 10.

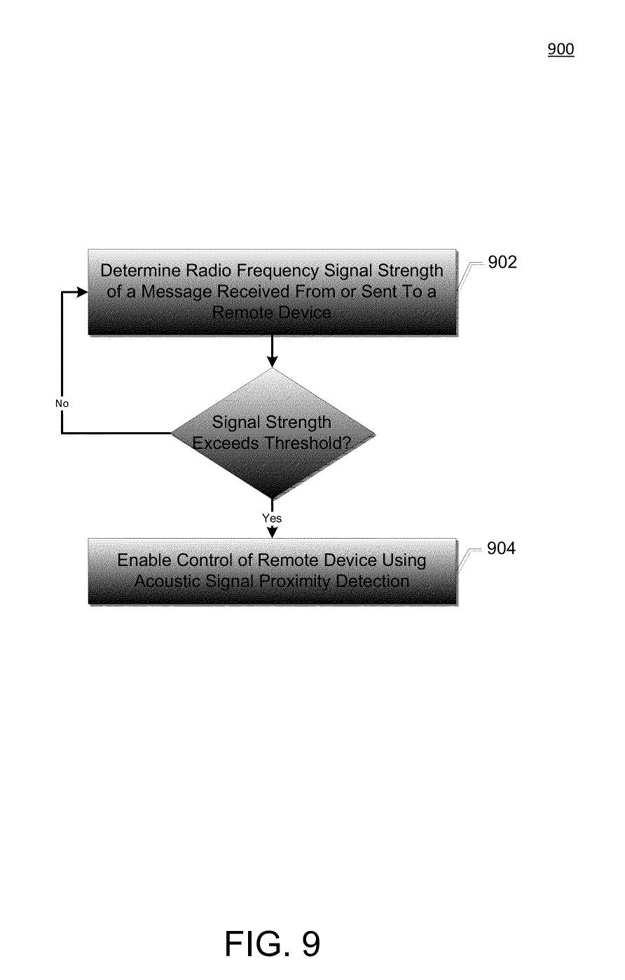

FIG. 9 is a flow diagram depicting an example of a method 900 for controlling a remote device using radio frequency signal strength and acoustic proximity detection techniques in accordance with some example embodiments of the present invention. The method 900 may thus allow for a user device to enable control of a remote device using a distance measured by a radio frequency signal strength, and then to control the remote device using inputs detected according to an acoustic proximity detection technique. Embodiments of the method 800 may be performed by an apparatus, or a processing means of an apparatus, such as the processor 12 described above with respect to the apparatus 10.

At action 902, a radio frequency signal strength may be determined for communications (e.g., messages sent to and/or received from) between a user device and a remote device. As described above, the radio frequency signal strength may be indicative of a distance between the user device and the remote device, as the signal strength generally increases as the distance between the devices decreases. The radio frequency signal strength may be determined by a processing means, such as the processor 10 described above with respect to the apparatus 10.

At action 904, the method 900 may determine whether the radio frequency signal strength is greater than a threshold signal strength. In some embodiments, the threshold signal strength may correspond to a certain distance, such as the control radius associated with the user device or a remote device. As such, the radio frequency signal strength may be used to determine if the distance between the user device and the remote device is less than the control radius. For example, if the radio frequency signal strength exceeds a certain value, then the method 900 may determine that the user device and the remote device are likely within a certain distance of one another. In some embodiments, the threshold signal strength may be determined as a result of a negotiation process between the user device and the remote device. For example, the user device and the remote device may communicate with one another (e.g., via a wireless protocol) to notify one another of various parameters of each device, such as the transmission strength of antenna or other electronic components associated with the signal strength of each device. These parameters may be used to calibrate a signal strength to distance ratio which may be used to determine the threshold signal strength. If the signal strength does not exceed the threshold signal strength, then the method 900 may return to action 902. If the signal strength exceeds the threshold signal strength, then the method 900 may proceed to action 906. The determination as to whether the signal strength exceeds the threshold signal strength may be performed by a processing means, such as the processor 10 described above with respect to the apparatus 10

At action 906, control of the remote device is enabled using acoustic signal proximity detection. As described above with respect to FIGS. 2-8, acoustic signal proximity detection may be utilized to provide input to the remote device. The acoustic signal proximity detection may provide for an increased granularity in distance measurement than the radio frequency signal strength calculation described above, due to the potential for increased accuracy in distance measurements when using acoustic signal proximity detection. In some embodiments, the acoustic signal proximity detection may be used to identify gesture inputs using the user device. These gesture inputs may be used to control the remote device. Control of the remote device may be enabled by a processing means, such as the processor 10 described above with respect to the apparatus 10.

As described above, FIGS. 4-5 and 7-9 illustrate flowcharts of an apparatus 10, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 14 of an apparatus employing an embodiment of the present invention and executed by a processor 12 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. The computer program product may be embodied as an application (e.g., an app), that is configured to implement, for example, at least certain ones of the operations of the flowcharts of FIGS. 4-5 and 7-9.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining, with a processor, that a radio frequency signal strength of one or more messages at least one of received from or transmitted to a remote device exceeds a threshold level; and
in response to determining that the signal strength of the one or more messages received from or transmitted to the remote device exceeds the threshold level, triggering acoustic signal based proximity detection for enabling controlling the remote device.

2. The method of claim 1, wherein
the threshold level for the radio frequency signal strength is associated with a control radius for the remote device for triggering acoustic signal based proximity detection.

3. The method of claim 1, wherein the acoustic proximity measurement technique comprises at least one of measuring a sound wave propagation time from a speaker of one of a user device or the remote device to a microphone of the other of the user device or the remote device.

4. The method of claim 1, wherein the acoustic signal based proximity detection is used to enable gesture based control of the remote device.

5. The method of claim 4, wherein the remote device comprises a speaker, and wherein acoustic signal based proximity detection is used to at least one of change the volume of the speaker, change the direction of the speaker output, or initiate output by the speaker of audio received from a user device.

6. The method of claim 5, further comprising receiving a gesture input by acoustic signal based proximity detection to control the volume of the speaker by rotating the user device in a clockwise manner to increase the volume and a counter-clockwise manner to decrease the volume.

7. The method of claim 4, wherein the remote device comprises a display, and the method further comprises receiving a gesture input by acoustic signal based proximity detection to alter the contents of the display.

8. The method of claim 4 further comprising receiving a gesture input by acoustic signal based proximity detection, and, in response to receiving the gesture input, causing a file to be at least one of sent to or received form the remote device.

9. The method of claim 3, wherein the user device is a cellular phone.

10. An apparatus comprising a processor and a memory storing program code instructions therein, the memory and program code instructions being configured to, with the processor, cause the apparatus to at least:
determine that a radio frequency signal strength of one or more messages at least one of received from or transmitted to a remote device exceeds a threshold level; and
in response to determining that the signal strength of the one or more messages received from or transmitted to the remote device exceeds the threshold level, trigger acoustic signal based proximity detection for enabling controlling the remote device.

11. The apparatus of claim 10, wherein
the threshold level for the radio frequency signal strength is associated with a control radius for the remote device for triggering acoustic signal based proximity detection.

12. The apparatus of claim 10, wherein the acoustic proximity measurement technique comprises at least one of measuring a sound wave propagation time from a speaker of one of a user device or the remote device to a microphone of the other of the user device or the remote device.

13. The apparatus of claim 10, wherein the acoustic signal based proximity detection is used to enable gesture based control of the remote device.

14. The apparatus of claim 13, wherein the apparatus is further configured to use acoustic signal proximity detection to at least one of change the volume of a speaker, change the direction of an output of the speaker, or initiate output by the speaker of audio received from the apparatus.

15. The apparatus of claim 14, wherein the apparatus is further configured to receive a gesture input by acoustic signal based proximity detection to control the volume of the speaker by rotating the user device in a clockwise manner to increase the volume and a counter-clockwise manner to decrease the volume.

16. The apparatus of claim 13, wherein the apparatus is further configured to receive a gesture input by acoustic signal based proximity detection to alter the contents of a display.

17. The apparatus of claim 13 wherein the apparatus is further configured to receive a gesture input by acoustic signal based proximity detection, and, in response to receiving the gesture input, cause a file to be at least one of sent to or received form the remote device.

18. The apparatus of claim 10, wherein the apparatus is a cellular phone.

19. A computer program product comprising at least one non-transitory computer-readable storage medium having executable computer-readable program code portions stored therein, the computer-readable program code portions comprising:
a first program code configured to, upon execution, cause an apparatus to determine that a radio frequency signal strength of one or more messages at least one of received from or transmitted to a remote device exceeds a threshold level; and
a second program code configured to, upon execution and in response to determining that the signal strength of the one or more messages received from or transmitted to the remote device exceeds the threshold level, cause the apparatus to trigger acoustic signal based proximity detection for enabling controlling the remote device.

20. The computer program product of claim 19, wherein the acoustic signal based proximity detection is used to enable gesture based control of the remote device.
